(19) United States
(12) Patent Application Publication
(10) Pub. No.: US 2013/0115405 A1
(43) Pub. Date: May 9, 2013

(54) TPU LAMINATING ADHESIVE

(71) Applicant: Henkel AG & Co. KGaA, Duesseldorf (DE)

(72) Inventors: Hans-Georg Kinzelmann, Pulheim (DE); Thorsten Schmidt, Ratingen (DE)

(73) Assignee: Henkel AG & Co. KGaA, Duesseldorf (DE)

(21) Appl. No.: 13/723,383

(22) Filed: Dec. 21, 2012

Related U.S. Application Data
(63) Continuation of application No. PCT/EP2011/058515, filed on May 25, 2011.

(30) Foreign Application Priority Data
Jun. 23, 2010 (DE) 102010030437.9

(51) Int. Cl. C09J 175/04

(52) U.S. Cl. CPC C09J 175/04
USPC 428/57; 156/331.7; 428/425.8

(57) ABSTRACT

A hot melt adhesive, having a viscosity from 10,000 mPas to 150,000 mPas at 140° C., containing at least 75 wt % of a thermoplastic polyurethane having an average molecular weight from 5000 to 40,000 g/mol and method of making a composite film using this adhesive.

The invention relates to an adhesive based on thermoplastic nonreactive polyurethanes, for manufacturing composite films that can be used as packaging. These adhesives are intended to contain no solvent, and to enable good adhesive bonding of films.

Laminating adhesives for bonding film-shaped substrates are commonly known. Adhesives based on reactive polyurethanes have proven particularly successful in practice. For example, DE 10 2004 018048 describes PU adhesives that can be manufactured on the basis of PU prepolymers having terminal isocyanate groups. These prepolymers comprise terminal isocyanate groups. They are usable for adhesive bonding of films to yield multi-layer composite materials.

These reactive adhesives having NCO groups have the disadvantage that unreacted monomeric isocyanates can still be contained in the adhesive layer after the multi-layer films have been manufactured. These monomers are contained only in small quantities, but are still physiologically objectionable. They can finish reacting with water, but then yield primary amines, in particular primary aromatic amines. Low-molecular-weight isocyanates or low-molecular-weight amines are not permanently secured in the adhesive matrix, however, but instead can in some cases migrate into the film over time. This small proportion of migration-capable substances is problematic, however, because such film materials are used for the manufacture of packages for foods.

To avoid such migratory substances that are problematic in terms of food technology, WO 02 43956 describes flexible packaging laminates that contain only a small proportion of migratory substances. Poly-α-olefins, polyesters, or other thermoplastic materials are, in particular, described therein. Also mentioned as further polymers are acrylic esters, synthetic elastomers, EVA, polyethylene, and other vinyl copolymers. Because these polymers are manufactured without isocyanates, they consequently also contain no such contaminants.

Such adhesives often have a variety of disadvantages, however, in terms of adhesion and adhesive strength on substrates. These adhesives, however, also contain a number of additives, e.g. resins or plasticizers, that are necessary for appropriate processing. These are nevertheless still of low molecular weight with reference to the polymer. In the long term it is problematic that these adjuvants can migrate into the bonded films. It has been found that the good properties of polymers that contain urethane groups or urea groups cannot be achieved on a variety of substrates.

EP 1 323 800 describes a multi-layer film that comprises a polyethylene layer and on that layer a thermoplastic urethane film. One side having the urethane film is said to enable adhesive bonding to polar substrates; the other side, made of polyethylene, serves as an adhesive for another, nonpolar substrate. The two films can be coextruded together. The adhesive bonding of shoe materials is described as an intended use.

Continuous methods are often used in the manufacture of composite films. The films are, in web form, optionally imprinted, coated, bonded, and then rolled up and stored or packaged. It is necessary in this context for the adhesive to be applied only in thin layers onto the films. This requirement is on the one hand commercially based, since an elevated amount of adhesive would unnecessarily raise the price of the product, and on the other hand the application in a thin layer is also technically useful. In thicker layers, discolorations of the films can be observed. In addition, a maximum possible adhesion is achieved at a determinable layer thickness, and if the layer thickness is further increased this is often degraded, and the flexibility of the film is also negatively influenced. An object of the present invention is thus to furnish a thermoplastic polyurethane adhesive that is suitable for use as a laminating adhesive. The adhesive is intended to be capable of application in thin layers; in addition, the proportions of migratable, health-endangering substances, such as solvents, isocyanates, aromatic amines, acrylate monomers, are to be avoided. In addition, it is intended that films equipped with an adhesive layer can be stored.

The object is achieved by the use of a hot melt adhesive having a viscosity from 10,000 mPas to 150,000 mPas (140° C.), containing at least 75 wt % of a thermoplastic polyurethane having an average molecular weight from 5000 to 40,000 g/mol, as an adhesive for the adhesive bonding of film substrates.

A further subject of the invention is a composite film made of a flexible film and a plastic substrate, which is mutually bonded over its entire surface or in sub-regions by means of a thermoplastic polyurethane adhesive. The subjects can be embodied as a multi-layer film or as a composite made up of a film substrate and a shaped plastic container.

The hot melt adhesive to be used according to the present invention is made up in this context of the adhesive components known per se, a thermoplastic polyurethane, stabilizers, antioxidants, adhesion promoters, and optionally fillers, pigments, and/or small portions of tackifying resins.

An adhesive suitable according to the present invention must contain at least one thermoplastic polyurethane (TPU). The latter is not reactive. The polyurethane is made up of polyols and polyisocyanates. The known starting materials can be used; it is necessary only to ensure that the polymer no longer contains any reactive NCO groups. For example, aliphatic polyols, polyester polyols, polyether polyols, oleochemical polyols, polycarbonate polyols can be used to construct the TPU.

Examples of aliphatic polyols are ethylene glycol, propylene glycol, 1,4-butanediol, 1,5-pentanediol, 1,6-hexanediol, 1,7-heptanediol, 1,8-octanediol, and higher homologs or isomers thereof. Also suitable are higher-functional alcohols such as, for example, glycerol, trimethylolpropane, pentaerythritol, as well as oligomeric ethers of the aforesaid substances with themselves or mixed with two or more of the aforesaid ethers.

A preferred polyol component is reaction products of low-molecular-weight polyfunctional alcohols with alkylene oxides (so-called polyethers). The alkylene oxides by preference have 2 to 4 carbon atoms. For example, the reaction products of ethylene glycol, propylene glycol, isomeric butanediols, hexanediol, or 4,4′-dihydroxydiphenylpropane with ethylene oxide, propylene oxide, butylene oxide, or mixtures thereof, are suitable. Also suitable, in addition, are the reaction products of polyfunctional alcohols, such as glycerol, trimethylolethane or trimethylolpropane, pentaerythritol, sugar alcohols, or mixtures thereof, with the aforesaid alkylene oxides. The polyether polyols are manufactured, in a manner known to one skilled in the art, by reacting the starting compound via a reactive hydrogen atom with the aforesaid alkylene oxides. Polyether alcohols of this kind are commercially obtainable.

A further group of suitable polyols is polyester polyols. Polyester polyols of this kind preferably encompass the reaction products of polyfunctional, by preference difunctional alcohols and polyfunctional, by preference difunctional and/or trifunctional carboxylic acids. Instead of free polycarboxylic acids, the corresponding polycarboxylic acid anhydrides or corresponding polycarboxylic acid esters with alcohols having by preference 1 to 3 carbon atoms can be used. Hexanediol, 1,4-hydroxymethylcyclohexane, 2-methyl-1,3-propanediol, 1,2,4-butanetriol, triethylene glycol, tetraethylene glycol, ethylene glycol, polyethylene glycol, dipropylene glycol, polypropylene glycol, dibutylene glycol, and polybutylene glycol are particularly suitable for manufacturing polyester polyols of this kind.

The polycarboxylic acids can be aliphatic, cycloaliphatic, aromatic or heterocyclic or both. They can optionally be substituted, for example with alkyl groups, alkenyl groups, ether groups, or halides. Suitable polycarboxylic acids are, for example, succinic acid, adipic acid, suberic acid, azelaic acid, sebacic acid, phthalic acid, isophthalic acid, terephthalic acid, trimellitic acid, phthalic acid anhydride, tetrahydrophthalic acid anhydride, hexahydrophthalic acid anhydride, glutaric acid anhydride, maleic acid, maleic acid anhydride, fumaric acid, dimer fatty acid or trimer fatty acid, or mixtures of two or more thereof. Subordinate quantities of monofunctional fatty acids can optionally be present in the reaction mixture. The polyesters can optionally comprise a small proportion of carboxyl terminal groups.

Polyester polyols made from lactones, for example based on ε-caprolectone (also called “polycaprolactones”), or from hydroxycarboxylic acids, for example ω-hydroxyhexanoic acid, are likewise suitable.

Polyester polyols of oleochemical derivation can, however, also be used. Such polyester polyols can be manufactured, for example, by complete ring opening of epoxidized triglycerides of an at least partly olefinically unsaturated fatty-acid-containing fat mixture using one or more alcohols having 1 to 12 carbon atoms, and subsequent partial transesterification of the triglyceride derivatives to yield alkyl ester polyols having 1 to 12 carbon atoms in the alkyl residue. Further suitable are polyols dimer diols as well as castor oil and derivatives thereof.

The hydroxyfunctional polybutadienes, such as those obtainable e.g. under the trade name “Poly-bd,” can likewise be used as polyols for the compositions according to the present invention. Polycarbonate polyols are likewise suitable.

Suitable polyols can have a molecular weight from 250 to 10,000 g/mol. Diols are particularly suitable. It is also possible to replace portions of the polyols with analogous aminofunctional compounds. For example, difunctional secondary polyamines or amine-terminated polyethers can be added.

It is also possible to use small quantities of monoalcohols. These alcohols can be added in order to control molecular weight. The result is that NCO groups at the chain end are reacted to completion without substantially raising the molecular weight.

Suitable isocyanates for manufacturing the TPUs are aromatic, aliphatic, or cycloaliphatic polyisocyanates. These can be selected, for example, from 4,4′-diphenylmethane diisocyanate (MDI), hydrogenated or partly hydrogenated MDI (H12MDI, H6MDI), xylylene diisocyanate (XDI), tetramethylxylylene diisocyanate (TMXDI), 4,4′-diphenyldimethylmethane diisocyanate, di- and tetraalkylenediphenylmethane diisocyanate, 4,4′-dibenzyl diisocyanate, 1,3-phenylene diisocyanate, 1,4-phenylene diisocyanate, the isomers of toluylene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), tetramethoxybutane-1,4-diisocyanate, naphthalene-1,5-diisocyanate (NDI), butane-1,4-diisocyanate, hexane-1,6-diisocyanate (HDI), dicyclohexylmethane diisocyanate, 2,2,4-trimethylhexane-2,3,3-trimethylhexamethylene diisocyanate, cyclohexane-1,4-diisocyanate, ethylene diisocyanate, methylenetriphenyltriisocyanate (MIT), phthalic acid bisisocyanatoethyl ester, trimethylhexamethylene diisocyanate, 1,4-diisocyanatobutane, 1,12-diisocyanatododecane, and dimer fatty acid diisocyanate, lysine ester diisocyanate, 4,4-dicyclohexylmethane diisocyanate, 1,3-cyclohexane or 1,4-cyclohexane diisocyanate.

Suitable trifunctional isocyanates are those isocyanates that are produced by trimerization or oligomerization of diisocyanates, or by reacting diisocyanates with trifunctional hydroxyl-group-containing compounds. Examples thereof are trimerization products of the isocyanates HDI, MDI, or IPDI, or adducts of diisocyanates and low-molecular-weight triols, such as trimethylolpropane or glycerol.

The quantities of NCO and of OH groups for synthesis of the TPUs are selected so that an NCO:OH ratio below 1 is implemented, for example from 0.75 to 0.99:1, in particular from 0.80 to 0.95:1. TPUs that still contain further OH groups are produced in this context. Another embodiment first manufactures an NCO-containing pre-product by reaction at an NCO:OH ratio above 1, for example from 1.02 to 1.2:1; this is then completely reacted with monoalcohols or monoamines at the terminal groups. Non-functionalized chain ends are produced in this context.

A preferred embodiment of the invention uses aromatic isocyanates. A further preferred embodiment utilizes polyester diols as a polyol.

An embodiment of the invention uses, in particular, hot melt adhesives that have a tacky surface after application as a layer. This embodiment can be assisted by selection of the TPU. For example, an elevated number of OH groups in the polymer results in elevated tackiness. An NCO:OH ratio from 0.75 to 0.9:1, in particular above 0.8:1, is therefore selected for corresponding polymers. Tackiness can additionally be assisted by way of additives, as indicated below.

Another embodiment of the invention produces adhesive layers on a film, the adhesive layers having a blocking-resistant surface. The adhesive layer can, in this context, be stacked against the carrier film. Adhesion is achieved by bonding to a second substrate under pressure and at elevated temperature. Adhesives suitable for this embodiment have no tackiness; they are blocking-resistant.

The TPUs recited above can be used, and block resistance can be influenced by the selection of the polymer components. In particular, constituents that result in elevated crystallinity of the TPU lead to an improvement in block resistance. Polyester polyols, in particular, are used as a constituent of the TPU, for example more than 70 wt % based on the polyol component or exclusively, very particularly preferably those that contain aromatic polycarboxylic acids. Surface tackiness can furthermore be decreased by way of an elevated NCO:OH ratio, for example between 0.85:1 and 0.99:1.

In a very particularly preferred embodiment, short-chain aliphatic diols and triols having fewer than 8 carbon atoms are additionally added to the polyol component upon manufacture of the TPU. The quantity of low-molecular-weight polyols in terms of the polyol component is from 0.5 to 10 wt %, in particular between 1 and 7 wt %. TPUs of this kind exhibit elevated crystallinity. They are particularly suitable for use as an adhesive of the embodiment having a blocking-resistant surface.

Reaction can be effected using known methods, and PU polymers suitable according to the present invention can thereby be manufactured. This can occur, for example, at room temperature; elevated temperatures can also be utilized. The initial compounds generally react spontaneously with one another, but it may also be necessary to add catalysts, such as organometallic compounds or organic amino compounds. Tin-based catalysts, or those based on tertiary amines, are suitable here, for example. Preferably, however, catalysts can be avoided. In a less-preferred form, it is also possible to perform the reaction in solvents and then to remove the solvent from the mixture.

The intention is for non-crosslinking TPUs to be obtained. These therefore, once manufactured, contain no further NCO groups. It is further preferred if predominantly diols and diisocyanates are used for manufacture. Predominantly linear products that exhibit thermoplastic behavior are then obtained. The polyurethanes suitable according to the present invention can contain different segments in the polymer chain; for example, hard and soft segments can be contained. Mixtures of TPUs having different chemical compositions can, however, also be present. The molecular weight (number-average M_{N}, as determinable by GPC against a polystyrene standard) of the TPUs is intended to be between 5000 and 50,000 g/mol, in particular between 10,000 and 40,000 g/mol.

The adhesives suitable according to the present invention can additionally contain further additives or additional substances. Examples thereof are further thermoplastic polymers, stabilizers, adhesion promoters, antioxidants, as well as optionally fillers, pigments, and/or small proportions of tackifying resins.

Thermoplastic elastomers, polyamides, ethylene copolymers, polyolefins, or polyesters can be used in this context as additional inert polymers. Examples of thermoplastic elastomers are block copolymers containing one or more aromatic polyvinyl blocks and at least one elastomeric block, for example a polystyrene block and a substantially rubber-like polybutadiene or polyisoprene block. To improve thermal stability, the polybutadiene resp. polyisoprene block can be partly or entirely hydrogenated. Block copolymers of this kind are offered, as SBS (styrene-butadiene-styrene) copolymers, as SIS (styrene-isoprene-styrene) copolymers, or as SEBS (styrene-ethylene-butadiene-styrene) copolymers, by a variety of manufacturers.

Examples of further additional polymers are ethylene-vinyl acetate polymers. EVAs of this kind are known to one skilled in the art and can be obtained in a variety of molecular weights. It is likewise possible for these EVAs to comprise functional groups that, for example, influence the compatibility or polarity of the polymer. Polyesters can also be added, provided they exhibit thermoplastic behavior. Aliphatic components in the polyester increase the flexibility of the polymer; aromatic constituents increase strength.

In principle, it is necessary to ensure that the additional polymers are compatible with the TPU and also do not separate in the melted adhesive. An adhesive suitable according to the present invention is intended to contain at least 75% TPU based on the sum of the polymers, preferably at least 85%, in particular more than 97% TPU polymers.

An adhesive suitable according to the present invention can also contain adhesion promoters. These can also be reactive substances that can enter into a reaction with the substrate surface.

Examples of suitable adhesion promoters are organofunctional silanes, such as hydroxy-functional, (meth)acryloxy-functional, mercapto-functional, amino-functional, or epoxy-functional silanes, which additionally contain hydrolyzable silane substituents. Examples of mercapto-functional silanes are 3-mercaptopropyltrimethoxysilane. Examples of (meth)acryloxy-functional silanes are 3-acryloxypropyltrialkoxysilane or 3-methacryloxypropyltrialkoxysilane. Examples of epoxy-functional silanes are 3-glycidyloxymethyltrimethoxysilane, 3-glycidylmethyltriethoxysilane, or 2-glycidoxyethyltrimethoxysilane. Examples for amino functional silanes are aminopropylmethyldimethoxysilane, N-(2-aminoethyl)-3-aminopropyltrimethoxysilane (DAMO), N, N-di(2-aminoethyl)-3-aminopropyltrimethoxysilane, N-(2-aminoethyl)-N′-(2-aminoethyl)-3-aminopropyltrimethoxysilane, bis-(triethoxysilylpropyl)amine, N-(n-butyl)-3-aminopropyltriethoxysilane, or mixtures thereof. Correspondingly suitable compounds are likewise the analogous ethoxy or propoxy derivatives, also alkyldialkoxy derivatives or the derivates replaced with another alkyl group instead of the respective propyl group. Condensates of the aforesaid aminosilanes can also be used as adhesion promoter components. Adhesion promoters of this kind are known in the literature. They can optionally enter into a chemical reaction with the substrates.

The aforementioned adhesion promoters are used in the adhesive in quantities between 0 and 10 wt %, by preference between 0.2 and 5 wt %, particularly preferably between 0.5 and 3 wt %.

In addition, usual stabilizers can be added to the hot melt adhesive. These are compounds that protect the polymers from decomposition during processing. They can be antioxidants, stabilizers with respect to moisture, or light protection agents. They are added to the hot melt adhesive usually in quantities up to 3 wt %, by preference in quantities from approximately 0.1 to 2.0 wt %.

A hot melt adhesive suitable according to the present invention can contain small quantities of tackifying resins as a further constituent. The resin produces additional tackiness. These are, for example, resins that possess a softening point from 70 to 130° C. (ring and ball method, DIN 52011). They can be, for example, aromatic, aliphatic, or cycloaliphatic hydrocarbon resins, or also modified or hydrogenated hydrocarbon resins. Further examples are hydroabietyl alcohol and esters thereof; modified natural resins; alkyl esters of optionally partly hydrogenated rosin; terpene resins and hydrogenated derivatives thereof; acrylic acid copolymerizates, by preference styrene-acrylic acid copolymers, and resins based on functional hydrocarbon resins. Such resins can be used in a quantity from 0 to 15 wt % based on the total adhesive, but preferably 0 or up to 5 wt %. Resins are less suitable if the embodiment as a blocking-resistant adhesive is selected.

In a less-preferred embodiment, it is also possible to add dyes, pigments, or fillers to the adhesive. The quantity is intended to be less than 10 wt %. In particular, the adhesive according to the present invention is preferably intended to contain no solvents, plasticizers, or waxes in order to influence viscosity. It is also possible to manufacture suitable hot melt adhesives with no addition of resins. In particular, no compounds that can migrate, and can thus diffuse out of the adhesive into adjacent layers, are to be contained.

A suitable adhesive composition is a hot melt adhesive. It contains at least 75 wt % of one or more thermoplastic polyurethanes. Another embodiment can additionally contain up to 20 wt % further thermoplastic polymers, between 0.2 and 5 wt % adhesion promoters, up to 2 wt % stabilizers, and up to 15 wt % resins, the sum of the constituents yielding 100%. Adhesives suitable according to the present invention are intended to have a viscosity from 10,000 mPas to 150,000 mPas, measured at 140° C. In particular, the viscosity is intended to be from 40,000 to 80,000 mPas (per EN ISO 2555; cone/plate measuring head, 140° C., shear rate 50 s⁻¹). Low viscosities are favorable for the use according to the present invention in order to obtain a thin layer thickness for the adhesive. The substrates experience little thermal stress because of the low heat capacity of this adhesive layer.

In particular, the adhesive can be free of resins. A suitable adhesive is furthermore, as a bonded adhesive layer, substantially free of low-molecular-weight substances, i.e. it contains no migration-capable constituents. Possible residual NCO groups are also already completely reacted upon manufacture of the TPUs.

“Migration-capable constituents,” which are generally of low molecular weight, are understood, for example, as substances that have a molecular weight of less than 1000 g/mol. These constituents either can themselves migrate, or they can be extracted from the adhesive in aqueous solutions or in aqueous solutions with organic constituents, for example alcoholic solutions. Selection of the TPUs suitable according to the present invention makes it possible to limit or entirely avoid the use of such low-molecular-weight compounds.

The adhesives suitable according to the present invention are used as a laminating adhesive for bonding flexible films. Known films or web-shaped substrates can be used in this context. These can be made, for example, of metal foils, paper films, and/or plastic films as individual or multi-layer films. They can be imprinted or coated. These films either can be laminated onto one another, or it is also possible to adhesively bond them onto other substrates, such as especially plastics, constituting shaped substrates.

It is possible in this context for the surface of the substrates to be processed before adhesive bonding. It is usual to clean off adhering loose constituents. It is furthermore possible optionally to activate the surfaces, for example using a plasma or corona pretreatment; or primers are applied onto a substrate. In particular, it is not necessary to use primers when the adhesives according to the present invention are utilized.

The substrates can be coated or imprinted on the surface. The imprinted area can be coated with the adhesive, or an imprinted film can be bonded as a second substrate surface against a surface coated with the adhesive. It is advantageous according to the present invention if the adhesive is colorless and transparent. There is to be no impairment of a possible printed image. The layer thickness of the adhesive is intended to be between 0.5 and 100 μm, in particular up to 20 μm, preferably from 1 to 10 μm, in particular less than 5 μm.

The hot melt adhesive is heated to a temperature between 80 and 200° C., preferably from 100° C. to 180° C. It thereby becomes liquid and can be applied in a thin layer onto a substrate. The known application methods such as rolling, blading, or the use of slit nozzles can be carried out in this context. The viscosity of the adhesive is adapted to the application method. The skilled artisan can establish, in consideration of the thermal stability of the hot melt adhesive, a suitable application temperature and thus an adapted viscosity of the hot melt adhesive. An embodiment of the invention operates in such a way that immediately after application of the adhesive layer, a second film is applied as a further substrate onto the coated surface, and they are bonded to one another by pressure.

Another embodiment is configured in such a way that one film is entirely or partly coated with an adhesive. An adhesive is applied in a non-tacky composition, and a non-tacky layer results after cooling. This layer is non-blocking. A substrate coated in this fashion can be stored, including as a rolled-up film. It can then be unrolled again for further processing. The adhesive layer becomes activated when acted upon by heat, and can then be adhesively bonded under pressure to a second identical or different substrate film.

“Blocking-resistant,” or “a non-blocking” coating, is to be understood to mean that an adhesive layer can be stored superimposed on a further carrier film without a protective layer, an adhesive layer being located opposite a film layer. Such layers can be separated from one another without a great deal of adhesion.

A test for block resistance is understood for purposes of the invention as a method in which a coated film substrate, for example a polyester film, is coated with approx. 10 μm of an adhesive according to the present invention. This adhesive layer is cooled, and an area of 100 cm² is pressed against an uncoated identical film substrate. A pressure of 10 tonnes is exerted for 24 hours. The layers are then to be separated by pulling manually. Adhesive separation is observed in this context; no film tearing of the substrate, or cohesive fracture, occurs.

Substrates coated in this fashion according to the present invention can be further processed in the manufacture of laminates and composites. For this, they are hot-pressed onto a further substrate. This is understood to mean that the adhesive layer of the coated substrate is reactivated by heat and is areally joined to the other substrate by pressure, and curing then occurs. The temperature is intended to be between 80 and 180° C. The compression pressure in the hot-pressing operation is usually in the range from 5 to 200 bar, depending on the machinery and depending on the laminates or composites to be manufactured. Establishment of the optimum pressure for the particular combination is a matter of the skilled artisan's experience.

Also a subject of the invention is a composite film manufactured from at least one film and a plastic substrate, which are adhesively bonded with an adhesive layer of a laminating adhesive, that is suitable according to the present invention and is based on TPU. These films are the known flexible films or multi-layer films made of plastic materials, which are suitable for packages. Further additional layers can optionally also be contained, such as metallized layers or SiOx layers. A plastic film or a metal foil can be adhesively bonded as a second substrate, or multi-layer films are bonded as substrates. In this context, at least two layers are joined to one another with the corresponding laminating adhesive. In a further embodiment, a (multi-layer) film is bonded to a shaped plastic substrate. The latter can be solid or can also exhibit flexible properties.

The adhesives suitable according to the present invention exhibit good adhesion to the substrates. For example, films based on polyesters, polyolefins, polyamides, or ethylene-vinyl acetate exhibit good adhesion to the adhesive. Solid substrates, for example made of polystyrene, can likewise be effectively bonded. Adhesion to aluminum foils or surfaces is, in particular, very good. In an embodiment, the substrates are bonded to one another over their entire surface by means of tacky TPU. Stable multi-layer composite films can thereby be obtained.

According to another embodiment of the invention, two substrates are adhesively bonded only in one or more edge regions. These regions are selected, for example, in such a way that continuous adhesive bonding, e.g. in the shape of a ring, of the substrates to one another occurs. In accordance with this embodiment, for example, an already three-dimensionally shaped multi-layer film or a solid substrate, e.g. in the shape of a cup, is adhesively bonded to a film coated according to the present invention. The hot melt adhesive suitable according to the present invention can be applied on a predetermined bonding region. The latter is then sealed to the shaped film member.

An embodiment selects the adhesive in such a way that adhesive fracture is observed. The adhesively bonded substrates can then be separated. In a further embodiment, the adhesive suitable according to the present invention is selected so that the cohesion of the adhesive layer is less than the adhesion. It is thereby possible to mechanically separate the two bonded substrates from one another. A cohesive fracture of the adhesive layer is observed. After separation, two surfaces that have a tacky property are obtained. Surfaces that can be re-adhered are obtained. Because these edge regions are, for example, arranged one above another as a result of the shape of the package, they can easily be bonded onto one another. The composite film that is adhesively bonded by way of a TPU adhesive according to the present invention can therefore be processed into packages that have a reclosable closure. These embodiments are usually referred to as a “sealing adhesive.”

The laminating adhesive suitable according to the present invention contains TPU which contains no further reactive isocyanates or isocyanate groups. In addition, the reaction procedure also ensures that no hydrolysis products of isocyanates with water, in particular primary aromatic amines, are contained. The TPU according to the present invention is a hot melt adhesive, i.e. it is free of organic solvents or plasticizers. It is possible to select the further additives in such a way that said additives have a higher molecular weight. As a result, they can be incorporated in stable fashion into the adhesive matrix, i.e. exhibit no, or only reduced, diffusion capability. Composite films made of films adhesively bonded with a laminating adhesive according to the present invention are therefore suitable for use as packaging for sensitive goods, for example foods or medical items.

The film substrates manufactured according to the present invention can be used for a variety of kinds of packages. These can be food packages, packages for medical purposes, or other film packages. It is also possible to sterilize the substrates bonded according to the present invention after packaged objects have been manufactured. This can occur, for example, by irradiation. Thanks to the selection of the TPUs, no delamination is observed even under moisture stress.

### EXAMPLES

### Examples 1

An OH-terminated thermoplastic PU is manufactured from a polyester (isophthalic acid, adipic acid, diethylene glycol, OH number 138), 77.4%, reacted in the melt with 22.6% MDI, NCO:OH 0.95:1.

Molecular weight: 20,000 g/mol (GPC)
Viscosity: 50,000 mPas (cone/plate, 140° C., shear rate 50 s⁻¹)

### Example 2

An OH-terminated thermoplastic PU is manufactured from a polyester (isophthalic acid, adipic acid, diethylene glycol, OH number 64), 89.7%, reacted in the melt with 10.3% MDI, NCO:OH 0.8:1.

Molecular weight: 10,000 g/mol (GPC)
Viscosity: 15,000 mPas (cone/plate, 140° C., shear rate 50)

### Example 3

A hot melt adhesive is manufactured from a TPU according to Example 1 together with 0.5% of an aminosilane and 0.5% of a stabilizer (Irganox 1010).

Composite films are manufactured from the adhesives of Examples 1 to 3:
a) Al against PE film
b) OPP against metallized OPP film
c) PA against OPP film.
   Laminated in the laboratory at approx. 7 g/m² or approx. 3 g/m².

Stable composites with good appearance are produced.

Composite adhesion for a) (7 g/m²): 6.5 N/15 mm.

Composite adhesion for b) (7 g/m²): 2.5 N/15 mm.

Composite adhesion is measured with an Instron 4301 tensile tester. Test specimens 15 mm wide are produced, and measured at a tearing speed of 100 mm/min at 25° C. The pulling angle is 90°.

### Example 4

An OH-terminated thermoplastic PU is manufactured from a polyester (isophthalic acid, adipic acid, diethylene glycol, OH number 138), 77.0%, and 0.7% hexanediol %, reacted in the melt with MDI at an NCO:OH ratio of 0.95:1.

The adhesive is applied at 10 μm in the laboratory onto a polyester film (approx. 30 μm), and after cooling, placed against an identical polyester film, pressed at 10 tonnes for 24 h at 23° C., and stored.

After storage, the films can be separated by hand with no tearing of the film.

What is claimed is:

1. A method of making a composite film, comprising:
providing a first film having a substrate;
providing a hot melt adhesive having a viscosity from 10,000 mPas to 150,000 mPas at 140° C., containing at least 75 wt % of a thermoplastic polyurethane (TPU) having an average molecular weight from 5000 to 40,000 g/mol;
heating the hot melt adhesive to form a liquid state;
applying the liquid hot melt adhesive to at least a portion of the first film substrate;
applying a second film to the coated substrate.

2. The method according to claim 1, wherein the hot melt adhesive additionally contains up to 25 wt % additives.

3. The method according to claim 1, wherein the hot melt adhesive is free of solvents, plasticizers, waxes, and resins.

4. The method according to claim 1, wherein the thermoplastic polyurethane is manufactured from aromatic polyisocyanates and polyester diols with an NCO:OH ratio from 0.75 to 0.95:1.

5. The method according to claim 1, wherein the thickness of the applied adhesive is less than 20 μm.

6. The method according to claim 1, wherein the thermoplastic polyurethane is manufactured from polyisocyanates and polyester polyols as a polyol component.

7. The method according to claim 6, wherein the polyol component additionally contains 0.5 to 10 wt % aliphatic diols and/or triols having up to 8 carbon atoms.

8. The method according to claim 6 further comprising the step of cooling the applied hot melt adhesive, wherein the cooled hot melt adhesive is blocking-resistant.

9. The method according to claim 8, wherein the cooled hot melt adhesive is separable by cohesive fracture.

10. The method according to claim 6, wherein the NCO:OH ratio is from 0.85 to 0.99:1.

11. The method according to claim 1, wherein the applied hot melt adhesive is thermally activatable.

12. A composite film containing a plastic film and a metallized or metal foil, which are joined to one another by a solidified hot melt adhesive, having a viscosity from 10,000 mPas to 150,000 mPas at 140° C., containing at least 75 wt % of a thermoplastic polyurethane (TPU) having an average molecular weight from 5000 to 40,000 g/mol.

13. A package for food or pharmaceuticals comprising the composite film according to claim 12.

14. A composite film made up of a plastic substrate and a film, which are joined to one another at at least one edge region by a solidified hot melt adhesive, having a viscosity from 10,000 mPas to 150,000 mPas at 140° C., containing at least 75 wt % of a thermoplastic polyurethane (TPU) having an average molecular weight from 5000 to 40,000 g/mol, wherein the thermoplastic polyurethane contains polyester polyols as a polyol component.

15. The composite film according to claim 14, wherein the films can be separated by cohesive fracture in the adhesive bonding layer.
